(19) United States
(12) Patent Application Publication
(10) Pub. No.: US 2015/0045601 A1
(43) Pub. Date: Feb. 12, 2015

(54) Compact gas to liquid convertor

(71) Applicant: Jerry M. Edmondson, Newport Beach, CA (US)

(72) Inventor: Jerry M. Edmondson, Newport Beach, CA (US)

(21) Appl. No.: 13/987,583

(22) Filed: Aug. 9, 2013

(51) Int. Cl. C10G 5/06; B01J 19/24

(52) U.S. Cl. CPC C10G 5/06; B01J 19/24; C10G 2300/40; C10G 2300/1025; B01J 2219/24; B01J 2219/00761
USPC 585/310; 422/207

(57) ABSTRACT

The present invention, a unique method and means of thermal cracking the molecular structure of short chain hydrocarbon vapor for reforming into long chain molecular structure and conversion of a portion to hydrocarbon liquid, much less complicated and complex than presently employed methods and means, combines partial oxidation, fast pyrolysis, and rapid cooling in a unique sequence of events incorporating components, of unique configuration, compact and much more cost effective than the presently employed methods and means of performing gas to liquid conversion that requires a great difference between the cost of the gas vapor feedstock and the selling price of the liquid to justify capital investment in gas to liquid conversion systems. Relatively few conversion systems are operating now and/or under construction. The present invention will improve the economics of investing in conversion systems, and with the newly discovered abundant supply of natural gas add a significant volume of liquid hydrocarbons into the crude oil supply.

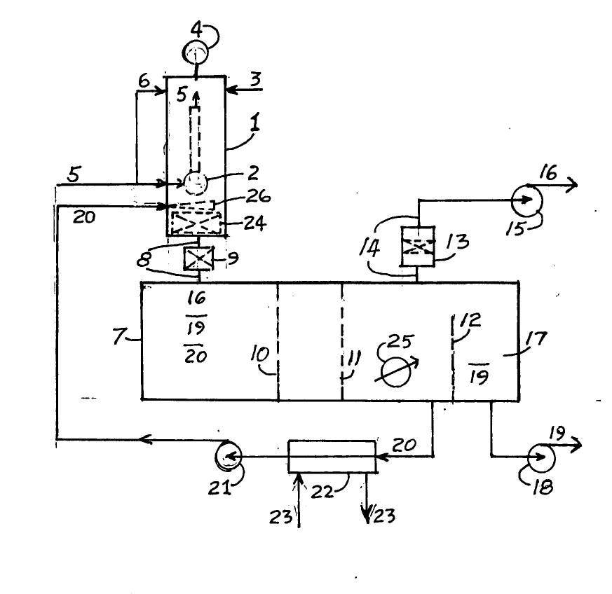

### FIELD OF THE INVENTION

The present invention relates generally to the conversion of hydrocarbon gas vapor into hydrocarbon liquid known in the industry as GTL gas to liquid. In particular the present invention teaches a very unique and cost effective method and means of performing the gas to liquids conversion.

### BACKGROUND OF THE INVENTION

Recently vast amounts of natural gas resources have become available through improved technology regarding the drilling and completion of oil and gas wells. The availability of abundant supplies of methane laden natural gas has driven down the price of said gas while the price of crude oil has remained high. This differential in price has stimulated investment in the construction of a few GTL systems. However, despite the large differential in price of the feedstock natural gas and the liquid product, the very high cost of constructing and operating the GTL systems, and the long lead time from initiation of construction and commercial operation has greatly constricted development. The introduction, to the industry, of my compact gas to liquids invention will change the situation dramatically. The few GTL systems recently put on stream, and or under construction having liquid production capacities of 80,000 B/D to 90,000 B/D each, cost between US $15 billion and $25 billion each. Incorporating construction and operation of eighty to ninety GTL plants applying the method and means of my invention producing 80,000 B/D to 90,000 B/D of total hydrocarbon liquid will cost less than US $2 billion. Where others have relied on some version and/or variation of the Fischer-Tropsch process my invention utilizes application of the well known, but virtually abandoned, process of molecular structure cracking with heat. Using the unique method and means of my invention, whereby, instead of cracking long chain molecular structures to produce short chain structures, my invention reverses the process and teaches the thermal cracking of short chain molecular structures for reforming into long chain structures. Applying teaching of my invention, cracked short chain structures are reformed into long chain molecular structures and a portion into hydrocarbon liquid.

A search for prior art will produce a lot of information about the Fischer-Tropsch process and variations thereof such as Wang U.S. Pat. No. 6,797,252, Marion U.S. Pat. No. 4,110,359, Robin U.S. Pat. No. 5,441,990 and Senetar U.S. Pat. No. 6,342,197 and articles and literature such as “Fuel Reforming”-UMPC, and “Maximizing H2 Production” by P. S. Malaya, the first discussing cracking to create shorter chain molecular structures and the latter improvement of Fischer-Tropsch process, but devoid of thermal cracking and reforming disclosures relating to reforming short chain molecular structures into long chain molecular structures. My invention stands alone in its teachings.

### SUMMARY

It is the intention of the Inventor to teach a unique and cost effective method and means of taking advantage of the availability of an abundance of methane laden natural gas comprised of short chain molecular structures and by applying the teachings of the present invention reform the short chain molecular structures into long chain structures and a portion into hydrocarbon liquid. This revolutionary method and means of adding additional hydrocarbon liquid into the supply of crude oil will be of great value to the world economy. The uniqueness of the configurations, structures and arrangement of the apparatus and the ingenious sequencing of events relative to the process will become apparent upon a study of the drawing, and a careful reading of the specifications and the appended claims.

### BRIEF DESCRIPTION OF THE DRAWING

For a more detailed understanding of the present invention, reference is made to the accompanying drawing. The drawing is a schematic representation of all of the essential components of the preferred embodiment.

### DETAILED DESCRIPTION OF THE PREFERRED EMBODIMENT

There is shown in the drawing a reformer column 1, of vertical, elongate configuration, containing, inside, a heat exchange device 2, also the said reformer column 1 has an air and/or oxygen inlet 3, an electric ignition and oxidation surveillance device 4, a gas vapor inlet 5, and a fuel gas inlet 6. The said reformer column 1, which may include, active or inactive, porous material 24 within its confines, is connected to a horizontal elongate vessel 7 by a connecting conduit 8 that may also contain a mixing and contacting device 9. The said vessel 7 may include devices as depicted by items 10 and 11 that are constructed in a manner to perform forced coalescence and rapid gravity separation. There may be a partial bulkhead 12 serving as a partition to provide a storage area 17 integral to said vessel 7 for the temporary storage of hydrocarbon liquid 19. There may also be included a vapor cleansing device 13, connected to said vessel 7 as part of the conduit 14 through which excess vapor 16 exits the vessel via a fan/blower device 15. Said hydrocarbon liquid 19 may be delivered from the said storage area 17 via pump 18. There will be a suitable quenching hydrocarbon extraction and liquefaction solution 20 circulated by the pump 21 from the said vessel 7 into the said reformer column 1 that may include a spraying device 26 for dispersal of said solution 20 upon its entry into the said reformer column 1. The said solution 20 may be heated utilizing a heating means 25 and/or cooled utilizing a heat exchanger 22 from which heat is extracted by extraction means 23. Where most of the other, present, gas to liquid conversion systems are employing some version of the very complex, energy intense and hugely expensive Fischer Tropsch process, my invention incorporates a tried and proved high temperature molecular structure “cracking” process operating at a slight vacuum pressure. My invention, however, teaches its application in a unique, quite simple and cost effective manner.

After the carbon and hydrogen bonds of the short chain molecular structures of the said feedstock gas vapor 5 are broken through intense heating they are rejoined as long chain molecular structures and a substantial quantity liquefied starting with heat extraction by the said heat exchanger 2 and finally through rapid cooling and absorption by the said quenching hydrocarbon extraction solution 20. Said feedstock gas vapor 5 upon entering reformer column 1 travels through the heat exchange device 2 which is one of the most unique embellishments of my invention, conserving a large amount of energy by heat exchange, preheating the feedstock gas vapor 5 flowing upward inside the heat exchanger 2 by absorbing heat from the vapor mass flowing downward, inside the said reformer column 1, and outside said heat exchanger 2 surface. The feedstock gas vapor 5, thusly preheated, will have its sensible heat further elevated as required to accomplish said “cracking”, with endothermic heat absorption utilizing heat generated by the exothermic chemical reaction of oxidation through mixing the fuel 6 with the air/oxygen 3 in the presence of an ignition device 4.

The temperature of said feedstock gas 5 shall be elevated to that required to accomplish breaking the carbon/hydrogen molecular bond and to stimulate Brownian Motion of the separated molecules thusly encouraging the rebonding as longer chain molecular structures. The said oxidation is conducted with sub-stoichiometric conditions that will produce some CO and H2 compounds whereby, in conjunction with the exposure to and mixing into the said quenching hydrocarbon extraction solution 20, through a chemical reaction similar to Fischer Tropsch process, will produce a relatively small volume of hydrocarbon liquid that is “seed” to start a liquefaction process, similar to lean oil absorption, wherein the majority of the said hydrocarbon liquid 19 is formed. The said hydrocarbon liquid 19 is mixed with the said extraction solution 20 and enters the said vessel 7 as an emulsion with the said solution 20 along with the excess vapor 16. The said vessel 7 performs as a gravity separator to permit the said vapor 16, said hydrocarbon liquid 19 and the said extraction solution 20 to separate into different strata, separated by their different densities, one over the other with the said solution 20 as the most dense on bottom, the said hydrocarbon liquid 19 on top of the said solution 20 and the said vapor 16 being the least dense occupies the upper region of the said vessel 7.

Properly configured internal structures, represented by items 10 and 11 constructed to encourage liquid droplets to agglomerate and separate faster and a device illustrated as item 13 to cleanse the said excess vapor may be included to enhance the processing performance of my invention.

Describing the preferred embodiment per the above does not limit the scope of this invention from encompassing variations, modifications and equivalents of the subject matter that may be employed by others of ordinary skill in the art upon learning from the teachings of my invention. Particular structures, means, methods and compositions as described herein shall have full scope of protection including equivalents and further, also, equivalents of all subject matter of the appended claims.

What is claimed is:

1. A method whereby a feedstock of hydrocarbon gas vapor such as methane laden natural gas is processed for the purpose of converting, at least, some of said vapor to hydrocarbon liquid comprising: heating and thus raising the temperature of said vapor to break the short chain carbon and hydrogen bond molecular structure, mixing the heated said vapor with a suitable liquid to quickly quench and cool said vapor to form long chain carbon and hydrogen bond molecular structure and thereby liquefy a portion of said vapor into hydrocarbon liquid.

2. A means for converting at least some portion of a stream of hydrocarbon gas vapor such as methane laden natural gas into a hydrocarbon liquid comprising: a reformer column, containing a heat exchanger inside said column, a air/oxygen inlet, a natural gas inlet connected to said heat exchanger, an igniter, a quenching solution inlet that can include a spraying device, and an outlet for a mixture of vapor, quenching solution and hydrocarbon liquid to exit said reformer column.

3. The method of claim 1 including heat exchange whereby some of said heating of said feedstock vapor is through removal by absorption some of the imparted heat of said heating of said vapor prior to said mixing.

4. The method of claim 1 whereby endothermic heat is provided by exothermic chemical reaction wherein air/oxygen, fuel and ignition are combined to cause oxidation.

5. The method of claim 1 including the said suitable liquid may be, but not limited to, an aqueous alkaline solution and may or may not contain iron oxide powder suspended in said suitable liquid.

6. Claim 1 including processing the mixture of said suitable liquid, said hydrocarbon liquid, and said vapor for the purpose of separating them into the separate constituents of said suitable liquid, said hydrocarbon liquid, and said vapor.

7. Claim 1 including raising the temperature of said vapor above 1000 degree F., and then cooling the said suitable liquid, said hydrocarbon liquid and said vapor mixture to a temperature below the boiling temperature of water at the chosen processing pressure.

8. Claim 1 including a processing pressure lower than atmospheric pressure.

9. Claim 2 including a vessel for processing the said mixture of vapor, quenching solution and hydrocarbon liquid exiting the said reformer column to separate said mixture into individual constituents of said vapor, said quenching solution and said hydrocarbon liquid.

10. Claim 9 including within said vessel, when gravity separation is employed, internal structure(s) configured to enhance said gravity separation by agglomerating small liquid droplets.

11. Claim 2 including a porous material within said reformer column constructed from chemically active or chemically inactive material(s) at a location before said outlet for the said mixture of vapor, quenching solution and hydrocarbon liquid.

12. Claim 2 including a mixing device positioned at a location below the said inlet of said quenching liquid of said reformer column.

13. Claim 2 including a separate fuel gas inlet.

14. Claim 9 including a device for evacuating said vapor from said vessel while causing the processing pressure to be lower than atmospheric pressure.

15. Claim 9 including, within the said vessel for processing, a heating device.

16. Claim 9 including a means for removing heat from the said quenching liquid.

17. Claim 9 including means for circulating said quenching liquid.

18. Claim 9 including a partition, within said vessel for processing, constructed in a manner so as to provide a compartment for temporary storage of said hydrocarbon liquid.

19. Claim 9 including a means for pumping the said hydrocarbon liquid to evacuate it from said vessel.

20. Claim 9 including a means for cleansing said vapor exiting said vessel.
